(19) United States
(12) Patent Application Publication
(10) Pub. No.: US 2011/0260834 A1
(43) Pub. Date: Oct. 27, 2011

(54) Tracking the Usage of Wear Components by an Embedded RFID System

(76) Inventors: Danny Keith Chapman, Sadieville, KY (US); Kevin Dean Schoedinger, Lexington, KY (US); Mark Stephen Underwood, Lexington, KY (US)

(21) Appl. No.: 12/764,628

(22) Filed: Apr. 21, 2010

(51) Int. Cl. G01K 7/01

(52) U.S. Cl. 340/10.1

(57) ABSTRACT

An imaging apparatus having RFID tags associated with wearable components of a system to track the usage and wear levels of the wearable components. The RFID tags can be antennas formed from conductive material impregnated in the wear components such that the RFID tags are worn with the wearing of the wear components. The RFID tags may also be RFID chip tags having memory for storing information, a portion of which is updated in real time. The presence or absence of the impregnated antenna RFID tags or the updated information stored in the chip tags may be used to track usage and wear level of the wear components.

### BACKGROUND OF THE INVENTION

1. Field of the Invention

The present invention relates generally to radio frequency identification (RFID) tags and particularly to use of RFID tags disposed in wearable components of an imaging apparatus to detect the deterioration thereof.

2. DESCRIPTION OF THE RELATED ART

An imaging apparatus, such as a printer, a copier, or a multi-function printing device (MFP) typically includes wearable components such as tires, rollers, and belts that wear and/or deteriorate over the life of the imaging apparatus due to extensive use. The wearing of these wearable components may have a significant impact on the performance of the imaging apparatus. For example, wearing of pick tires and wear strips has been seen to significantly affect the reliability of picking sheets of media in an imaging apparatus. The wearing of fuser rollers has been seen to significantly affect media jam rates in the imaging apparatus. Some of these wearable components can be replaced by a user or by a service provider. Also, in some cases, the performance of the imaging apparatus can be adjusted based on level of wearing of the wearable components.

The present invention relates generally to an electro-photographic toner cartridge, and more specifically to a method for detecting low toner in an electro-photographic toner cartridge using a light beam to detect the presence or absence of toner in the cartridge.

For example, a fuser module of an imaging apparatus may include a fuser information chip (FIC) that stores the number of pages fed through the fuser module. This information can be used to track the usage of a fuser roller and potentially indicate to the user that the fuser roller has been used extensively and needs to be replaced. However, the use of the FIC requires user intervention to indicate whether the fuser roller has been replaced and when it has been replaced, and such user intervention is oftentimes unreliable.

Other wearable components, such as the pick tire and wear strips, due to their size, location, cost and other issues are unable to make use of the above-mentioned information chips. Further, users often swap components between different imaging apparatuses. For example, some users have taken pick tires from a first imaging apparatus and moved them to a second imaging apparatus. A controller associated with the first imaging apparatus, located away from the pick tire, stores number of pages that the pick tire has picked. However, removal of the pick roller from the first imaging apparatus and installation in the second imaging apparatus requires resetting of information in the controller associated with both imaging apparatuses, thereby requiring user intervention. Thus, one disadvantage of using the above method is that the data regarding the usage and/or wear pattern of the wearable component is stored in another component that does not automatically track the wearable component.

Based upon the foregoing, there is a need to track the usage of wearable components in an accurate and substantially automatic manner without considerable user intervention.

### SUMMARY OF THE EXEMPLARY EMBODIMENTS

Exemplary embodiments of the present invention address the shortcomings of prior attempts to track the wear of wearable components and thereby satisfy a significant need for a usage tracking apparatus and method therefore.

Exemplary embodiments of the present invention utilize RFID tags embedded in the wearable components in order to track the usage thereof in systems such as an image forming apparatus, and indicate when or whether the wearable components require replacement. RFID tags are widely used today for various purposes such as identification and location tracking An RFID tag typically includes two components—an integrated circuit chip with memory for storing information and an antenna that allows the chip to wirelessly communicate information with a reader, also known as interrogator. An RFID tag needs to be placed in relative proximity with the reader for communicating data therewith. RFID tags can be active or passive in nature. Active RFID tags have their own power source, such as a battery, while passive RFID tags rely entirely on the reader as their power source. In its simplest form, an RFID tag may not even have a chip and may include only the antenna that reflects the reader's signal back to the reader. In this case, the mere presence of the RFID tag, if detected by the reader, is considered to be the information stored by the RFID tag.

An RFID system allows the reader to access and communicate with the RFID tag via radio frequency. An ultra high frequency (UHF) RFID system can read and write at relatively long range, using what is commonly referred to as “far field” or “backscatter” radiation. However, UHF RFID systems are relatively costly and have certain potential FCC certification issues. Alternatively, a high frequency (HF) or low frequency (LF) RFID system can be used that read and write the tag at significantly shorter distances using RF communications by “near field” or “inductive coupling” with a coil-shaped antenna. The coil antenna is placed at a suitable distance from the RFID tag so that the RFID tag is able to transmit data to the coil antenna coupled to the reader such that the data is transmitted to the reader via electromagnetic coupling.

According to an exemplary embodiment of the present invention, there is shown a device for monitoring the wear of at least one wearable component of an apparatus, the device including at least one RFID tag disposed on or in the at least one wearable component of the apparatus; a reader communicatively coupled to at least one RFID tag; and a controller coupled to the reader to monitor the wear of at least one wearable component based upon signals received by the reader from the at least one RFID tag.

In some embodiments of the present invention, an antenna formed from a conductive material is impregnated in an outer portion of the at least one wearable component from an outer surface to a predetermined threshold depth. In this way, the antenna gradually deteriorates as the wearable component wears over time. At some point, the antenna is deteriorated to such an extent that it can no longer reflect signals transmitted by the reader, thereby indicating that the wearable component needs replacement. Signal strength analysis mechanisms may be employed by the controller to determine the extent of wear of the wearable component from first use through the antenna no longer sending a signal to the reader, and permitting the controlling device to adjust system operation to match the current wear level.

In another embodiment, the conductive material forming the antenna is impregnated in only a portion of a ring or annular band of the at least one wearable component. Movement of the wearable component may be detected by an antenna, such as a coil antenna, disposed proximally thereto and coupled to the reader so that usage of the wearable component may be monitored to determine whether the wearable component needs to be replaced or requires a change in its operation.

In another embodiment, the conductive material forming the antenna is impregnated at a predetermined depth in the at least one wearable component. In this way, the embedded antenna is able to reflect signals transmitted by the reader only after the wearable component has been sufficiently worn over time.

In another embodiment, the reader performs a signal strength analysis on the signals sent by the RFID tag to detect a wear pattern of the wearable component.

In another embodiment, an RFID chip tag is disposed on or in the wearable component and is unaffected by the wearable component wearing over time. Information about the use of the wearable component may be provided to the controller via the reader for determining an extent of wear of the wearable component and/or whether the wearable component needs replacement. The information is maintained in memory of the RFID chip tag, updated in real time, and accessible even when the wearable component is installed in another apparatus. The information stored may be, for example, page counts, revolution or rotation counts, time, or any other useful and quantifiable unit of measure.

### BRIEF DESCRIPTION OF THE DRAWINGS

FIG. 1 illustrates a side elevation view of an imaging apparatus that utilizes exemplary embodiments of present invention to monitor the wear of one or more wearable components using RFID tags;

FIG. 2 is a side or cross-sectional view of an exemplary embodiment of a pick member capable of use in the imaging apparatus of FIG. 1;

FIG. 3 is a side or cross-sectional view of another exemplary embodiment of a pick member for use in the imaging apparatus of FIG. 1;

FIG. 4 is a perspective view of the pick member of FIG. 3 in association with a coil antenna;

FIG. 5 is a side or cross-sectional view of an exemplary embodiment of the pick member capable of use in the imaging apparatus as shown in FIG. 1;

FIG. 6 is a side or cross-sectional view of an exemplary embodiment of a pick member capable of use in the imaging apparatus as shown in FIG. 1;

FIG. 7 is a perspective view of the pick member of FIG. 6 in association with a coil antenna; and

FIG. 8 is a flowchart demonstrating a method of tracking usage of the pick member of FIG. 7.

### BRIEF DESCRIPTION OF THE DRAWINGS

Reference will now be made in detail to the exemplary embodiment(s) of the invention as illustrated in the accompanying drawings. Whenever possible, the same reference numerals will be used throughout the drawings to refer to the same or like parts.

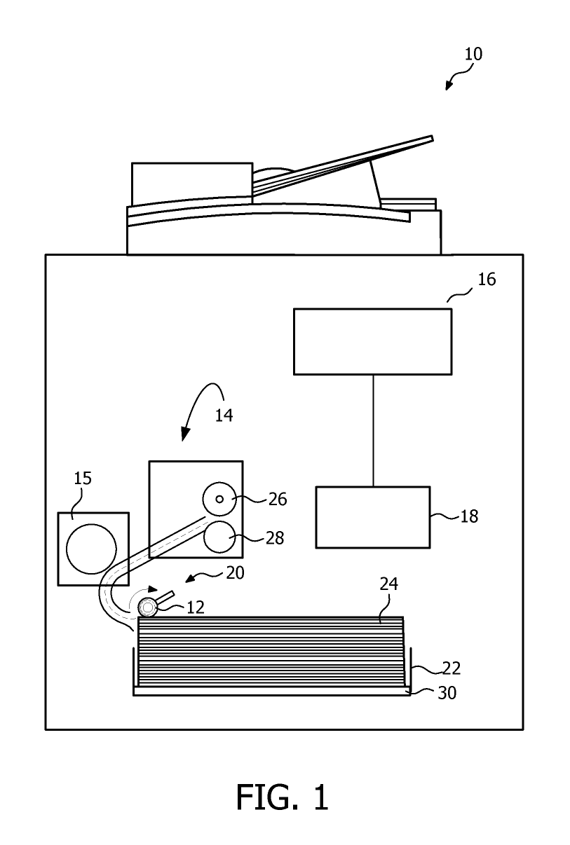

FIG. 1 illustrates a side elevation view of an imaging apparatus 10 for printing images onto sheets of media. Imaging apparatus 10 may include a pick member 12, a fuser module 14, an image transfer area 15, a controller 16 for controlling printing operations, and a reader/interrogator 18 associated with the controller 16 and in wireless communication with one or more RFID tags (not shown) disposed within the imaging apparatus 10. A pick mechanism 20, including the pick member 12 and a wear strip 30, is located adjacent to an input tray 22. Pick mechanism 20 serves to pick a top sheet from a stack of media sheets 24 residing in the input tray 22 of the imaging apparatus 10. The media sheet 24 picked up by the pick mechanism 20 is then moved to an image transfer area 15 for transferring a toner image to the media sheet 24. The imaged media sheet 24 is then transferred to a fuser module 14 where a fuser roller 26 along with a pressure roller 28 fuses the toner image to the media sheet 24 using heat and pressure.

Pick mechanism 20 picks a top sheet from the media stack 24 by placing pick member 12 on the media sheet stack 24 and rotating it under application of a force. With the pick member 12 being made of rubber, the regular rotation of the pick member 12 against the media sheet stack 24 undergoes wear over time.

The wear strip 30 may be a flat, stationary piece of material or a roller (not shown) and constructed from rubber or cork. Situated at the bottom of the input tray 22, wear strip 30 provides a relatively rough surface to grip the rest of the media sheet stack 24 while the pick member 12 picks the top-most sheet from the media sheet stack 24. Similar to the pick member 12, the wear strip 30 is also subject to wear over time and its effectiveness depends on its wear level.

Further, the fuser roller 26 that rotates against the pressure roller 28 is also prone to significant wear over time. The above-mentioned components, i.e., the pick member 12, the wear strip 30, and the fuser roller 26, represent some of the wearable components of the imaging apparatus 10 that would benefit from accurate and automatic wear monitoring. According to exemplary embodiments of the present invention, RFID tags are included on each in order to track the usage and/or wear thereof. The reader 18 may be located proximately to the RFID tags such that each RFID tag is able to communicate data therewith.

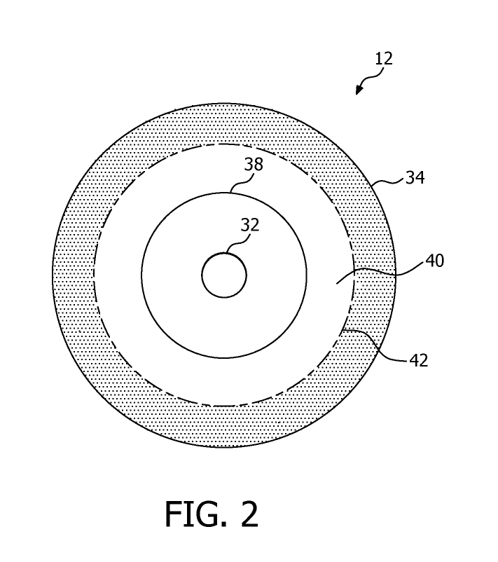

FIG. 2 illustrates a side elevation view of a wearable component of the imaging apparatus 10. The wearable component depicted in FIG. 2 may represent, for example, the pick member 12, the wear strip 30 (if configured as a roller), the fuser roller 26, or any other substantially circular or cylindrical wearable component of the imaging apparatus 10 working in a similar manner as discussed below. For the sake of simplicity, the wearable component shown in FIG. 2 will be described as the pick member 12 of the imaging apparatus 10.

The pick member 12 rotates about a wheel axle 32. A wheel hub 38 engages with and otherwise supports axle 32. A pick tire 40 is disposed about wheel hub 38. Pick tire 40 may be made of a thick, rubber material. An outer surface 34 of pick tire 40 forms a wearing surface of the pick member 12. An RFID ink tag 41 is impregnated in pick tire 40 from outer surface 34 to a predetermined threshold depth 42 within pick tire 40. Specifically, the RFID ink tag 41 may be formed from a conductive ink embedded within pick tire 40, such as silver ink, carbon ink, or any other conductive ink that is well known in the art. As the pick member 12 rotates against the media sheet stack 24, the pick tire 40 is worn with time. With the wearing of the outer surface 34, the RFID ink tag 41 also wears over time. The predetermined threshold depth 42 in the pick tire 40 is chosen such that if the outer surface of pick tire 40 is worn down to the threshold depth 42, the pick member 12 should be replaced because continued use of the worn out pick tire 40 will significantly affect pick reliability of media sheets and media jam rates in the imaging apparatus 10. The predetermined threshold depth 42 of pick tire 40 may be determined by a manufacturer of the pick member 12 based on material (rubber) information of the pick tire 40, the usage pattern thereof, etc.

A reader 18 (shown in FIG. 1) generates radio frequency signals and is placed in the imaging apparatus 10 proximate to the pick member 12 and RFID ink tag 41. Radio frequency signals generated by the reader 18 that reach the RFID ink tag 41 are reflected back to the reader 18, thereby indicating the presence of the RFID ink tag 41. However, when the outer surface of pick tire 40 is worn to the predetermined threshold depth 42, i.e., at a point where continued use of pick tire 40 is unreliable, there is not enough ink remaining in the pick member 12 to reflect the signal sent by the reader 18, thereby making it impossible for the reader 18 to reliably detect the presence of an RFID tag. Thus, detection by reader 18 of the RFID ink tag 41 indicates that pick member 12 may continue to be used, and failing to detect RFID ink tag 41 by reader 18 indicates that the pick member 12 (and/or pick tire 40) needs to be replaced.

In another embodiment according to the present invention, by using a more sophisticated reader, it is possible to differentiate a new, unworn pick tire 40 from a partially worn but still usable pick tire 40. According to this embodiment, the volume of conductive ink impregnated throughout the outer portion of pick tire 40 decreases gradually from the radially outermost location of pick tire 40 to the predetermined threshold depth 42. As pick tire wears over time, the amount of energy reflected by RFID ink tag 41 back to reader 18 gradually decreases. By using a more sophisticated reader 18 that can perform signal strength analysis on the reflected energy received thereby, it is possible to track how much the pick member 12 has worn at a given point of time.

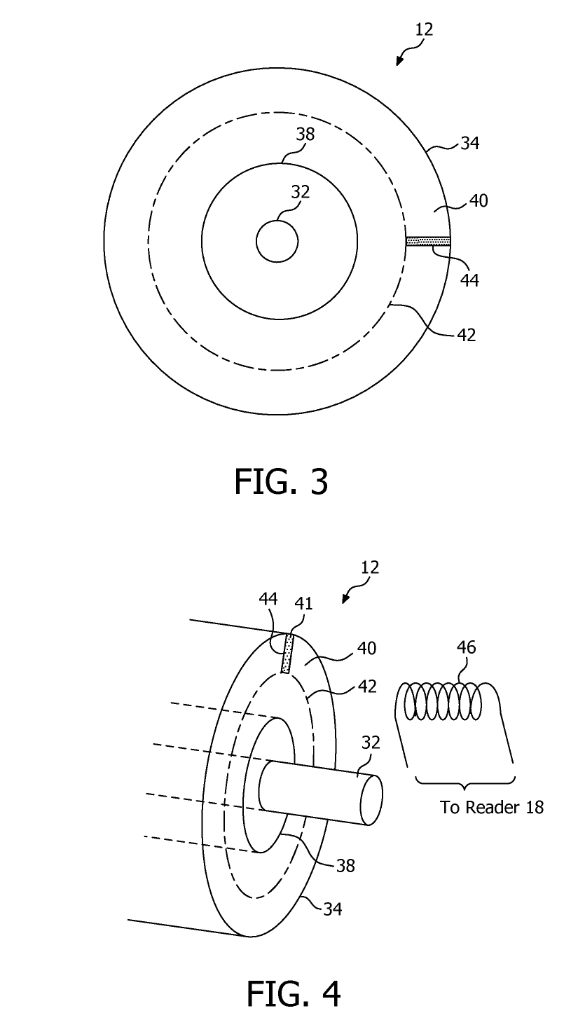

The RFID ink tag 41 can be impregnated around substantially the entire circumference of pick tire 40 as shown in FIG. 2 such that the area impregnated forms a substantially circular or annular band. Alternatively, RFID ink tag 41 may be impregnated in only a portion of the entire circumference of the pick tire 40 such that the area impregnated occupies only a portion of such annular band. FIG. 3 illustrates that the RFID ink tag 41 being embedded in pick tire 40 as a annular band portion 44 extending from the outer surface of pick tire 40 to the predetermined threshold depth 42. In this embodiment, the detection of the presence of the RFID ink tag 41 by the reader 18 (shown in FIG. 1) would indicate that the pick member 12 and/or pick tire 40 need not be replaced, while the reader 18 failing to detect the presence of the RFID ink tag 41 would indicate the need to replace the pick member 12 and/or pick tire 40. Further, this embodiment will also allow the reader 18 to track the number of pages picked (or alternatively, the number of tire revolutions performed) by the pick member 12.

FIG. 4 is a perspective view of the pick member 12 of FIG. 3 showing the presence of a coil-shaped antenna 46 proximal to the RFID ink tag 41. The coil antenna 46 may be placed on a pick arm (not shown) of the pick member 12 or at any place near the RFID ink tag 41 to ensure proper communication between the RFID ink tag 41 and the coil antenna 46. Each time the pick member 12 rotates to pick a page, due to the presence of the RFID conductive ink tag band portion 44 embedded in the outer surface 34 of the pick member 12, there is an inductive disturbance in the coil antenna 46. Thus, each pass of the RFID ink tag band portion 44 would cause an inductive change in the coil antenna 46 that is detectable by the reader 18. The detectable inductive change may then be interpreted as one revolution of the pick member 12. Further, when the pick member 12 wears to the predetermined threshold depth 42, there will be insufficient or no RFID ink tag 41 left on the pick tire 40 that would cause the inductive disturbance in the coil antenna 46, thereby indicating to the reader 18 that the pick member 12 needs to be replaced.

After receiving the data from RFID ink tag band portion 44 corresponding to a revolution of pick tire 40, the reader 18 sends the data to the controller 16 which then increments its page count. The controller 16 either stores or algorithmically calculates, based on property information of the pick tire 40, such as wear curves, material information, usage pattern, and/or the type of media picked by the pick member 12, a threshold page count for the pick tire 40 which indicates a maximum or near maximum number of pages remaining that can be picked by the pick member 12 before the efficiency thereof is compromised. The controller 16 may then compare the incremented page count and the threshold page count. If the incremented page count is less than threshold page count, then the controller 16 may adjust the operation of the pick member 12 to ensure substantially consistent performance as the pick tire 40 continues to wear. If the incremented page count is greater than or equal to the calculated threshold page count, the controller 16 may cause a message to be displayed or otherwise sent to the user indicating that replacement of the pick member 12 is warranted. Thus, with this embodiment, by determining the presence or absence of the RFID ink tag band portion 44, a user can track the number of pages picked, adjust the pick algorithm as the pick tire 40 wears, and determine when the pick member 12 needs to be replaced.

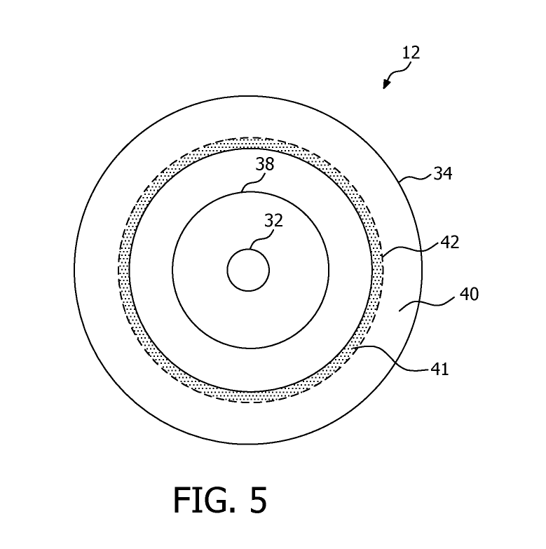

FIG. 5 shows a side elevation view of a pick member 12 according to another embodiment of the present invention. According to this embodiment, conductive ink forming the RFID ink tag 41 is impregnated in pick tire 40 at the predetermined threshold depth 42. A radially outer portion of pick tire 40 covers RFID ink tag 41. In this way, when the pick member 12 is new, the RFID ink tag 41 is not detected by the reader 18 due to the portion of material of pick tire 40 covering RFID ink tag 41. As the pick tire 40 wears over time such that the material of pick tire 40 covering RFID ink tag 41 has at least partly deteriorated, the RFID ink tag 41 becomes capable of sufficiently reflecting an RF signal transmitted by reader 18 so that it is detected thereby. However, unlike the previous embodiments in which the detection of a reflected signal indicates a reliable pick tire 40, in this case the detection of the signal reflected by the RFID ink tag 41 indicates that the pick member 12 needs to be replaced.

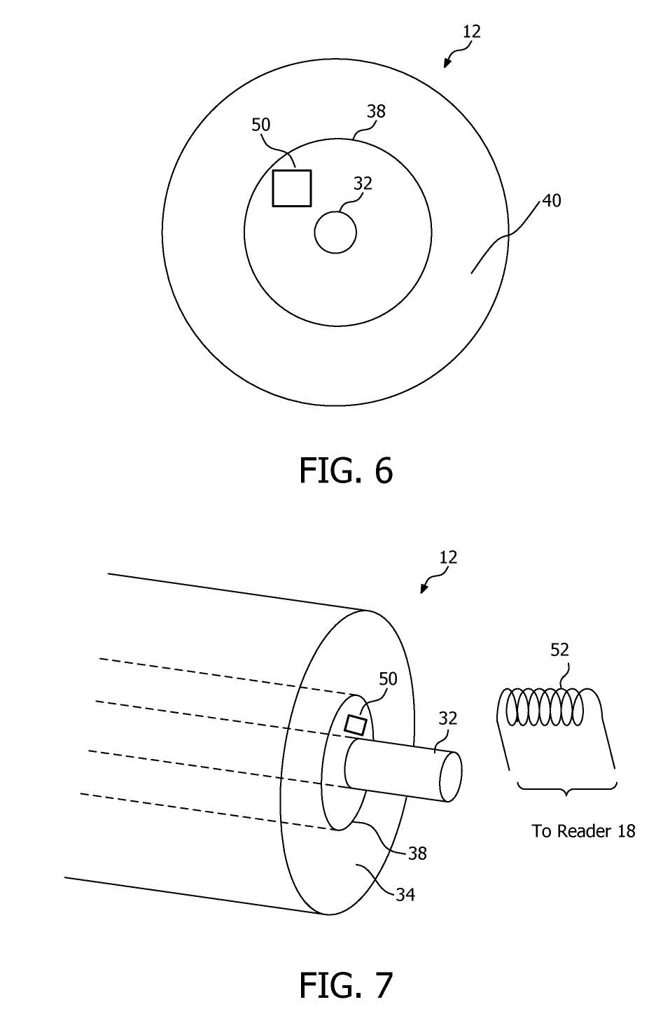

FIG. 6 illustrates a side elevation view of the pick member 12 according to another embodiment of the present invention showing an RFID chip tag 50 disposed in the wheel hub 38 of the pick member 12. The wheel hub 38 of the pick member 12 is not a wearing surface such that as the pick tire 40 wears, the RFID chip tag 50 is left intact. The RFID chip tag 50 communicates with the reader 18 either entirely via radio frequency or via a coil antenna 52 disposed proximate to the RFID chip tag 50, as shown in FIG. 7, depending on the type of RFID system being used. The RFID chip tag 50 includes an antenna (not shown) to communicate with the reader's antenna and also has memory to store information. The memory of the RFID chip tag 50 stores the number of pages picked by the pick member 12 as a page count. For a new pick member 12, the page count will be zero. The RFID chip tag 50 may also store information related to the wear pattern of the pick member 12 such as profile information correlating the speed of rotation of the pick member 12 with wear, the model number of the pick member 12, a list of known compatible imaging apparatus models, a threshold page count indicating the maximum number of pages that the pick member 12 can pick at a given rotation speed for a given type of media, etc. Once it is determined that the pick member 12 has picked the threshold number of pages, the imaging apparatus 10 either posts a warning message to a user and/or initiates other service notification actions such as sending an electronic mail to a system administrator, automatically ordering replacement parts etc.

It is understood that any antenna or member capable of receiving, reflecting and/or radiating radio waves may be employed in or with the embodiments described herein in place of coil antenna 46 or coil antenna 52.

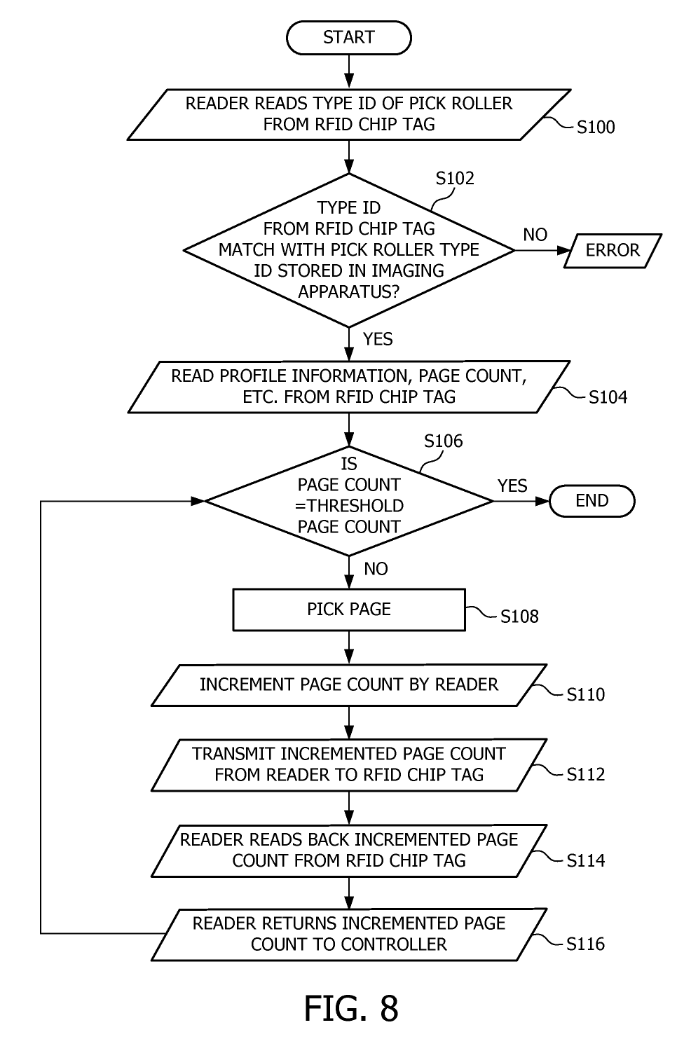

FIG. 8 is a flowchart demonstrating a method of tracking usage of the pick member 12 by using the RFID chip tag 50 according to an embodiment of the present invention. At block S100, the controller 16 directs the reader 18 to read the identification information of RFID chip tag 50 (i.e., the type ID) stored in its memory. At block S102, the controller 16 compares the type ID of the pick member 12 obtained by the reader 18 from the RFID chip tag 50 with identification information stored within the imaging apparatus. The imaging apparatus stores the identifications of pick rollers that are compatible with the imaging apparatus 10. If the controller 16 determines that the identification obtained from the RFID chip tag 50 does not match with identification information stored within the imaging apparatus 10, the controller 16 sends or displays an error message to the user indicating that the installed pick member 12 is not compatible with the imaging apparatus 10.

If the controller 16 determined that the RFID chip tag 50 is compatible with the imaging apparatus 10, then at block S104 the controller 16 directs the reader 18 to obtain additional information from the RFID chip tag 50. Additional information may include, for example, profile information of the pick member 12 and/or pick tire 40, a list of known compatible imaging apparatus models, a threshold page count indicating a page count for a given rotation speed and a given type of media above which pick tire 40 is seen to no longer reliably pick media sheets, and/or the page count associated with the number of media sheets previously picked by the pick tire 40. The imaging apparatus 10 stores the above information for future reference.

At block S106, the controller 16 compares the page count with the threshold page count to determine whether the page count is equal to the threshold page count. The threshold page count may be retrieved from the RFID chip tag 50 as described above, or calculated by controller 16 based on the profile information of the pick member 12 retrieved from the RFID chip tag 50. If it is determined by the controller 16 that the page count has reached or surpassed the threshold page count, the controller 16 indicates the user that the pick member 12 alerts the user of the imaging apparatus 10 that the pick member 12, and particularly the pick tire 40, cannot pick additional media sheets without compromising pick reliability.

However, if the controller 16 determines that the page count has still not reached the threshold page count, the controller 16 directs at block S108 the pick mechanism 20 to pick up a next media sheet for use in a print operation. After the pick mechanism 20 picks up the next media sheet, a sensor detects a successful pick up of the media sheet. Alternatively, utilizing the embodiment of FIGS. 3 and 4 in connection with RFID chip tag 50, rotation of the pick tire 40 during the pick operation is sensed by controller 16 via coil antenna 46. At block S110, the reader 18 increments the page count to obtain a new page count and transmits the new page count to RFID chip tag 50 at S112 for storage therein.

At block S114, the reader 18 reads back the new page count from the RFID chip tag 50 to ensure successful storing thereof in the RFID chip tag 50, and at S116 returns the incremented page count to the controller 16. Based upon the new page count value, the controller 16 may adjust the operation of the pick member 12 for a next pick operation. In this way, the information regarding the number of pages picked by the pick member 12 is stored in the pick member 12 itself so that the stored page count may be used if pick member 12 is moved to another imaging apparatus.

It is understood that the above-described embodiments with respect to the pick member 12 can also be used with respect to a wear strip 30, a fuser roller 26, or any other wearable component of the imaging apparatus 10. It is further understood that the above-described embodiments may also be used in connection with a wearable component in any system or apparatus, for monitoring wear and/or deterioration or performance thereof. For example, a motor vehicle may employ RFID ink tags and/or RFID chip tags as described above for monitoring the vehicle's tires, brakes, belts and the like.

In a system employing a plurality of wearable components being monitored, each wearable component may include an RFID ink tag 41 or an RFID chip tag 50 which communicates with at least one reader 18 disposed within the system. In a system utilizing multiple RFID ink tags 40, the reader 18 may employ multiplexing circuitry for receiving signals from each ink tag. In a system utilizing multiple RFID chip tags 50, a unique RFID chip tag ID may be associated with each RFID chip tag 50 so that the reader 18 is able to differentiate between signals received from the tags.

It will be apparent to those skilled in the art that various modifications and variations can be made to the present invention without departing from the spirit and scope of the invention. Thus, it is intended that the present invention cover the modifications and variations of this invention provided they come within the scope of the adapted claims and their equivalents.

What is claimed is:

1. A device to monitor wearing of at least one wearable component of a system, the device comprising:
a radio frequency identification (RFID) tag disposed in or on a component;
a reader communicatively coupled to the RFID tag; and
a controller coupled to the reader to monitor wear of the component based upon communication between the reader and the RFID tag.

2. The device of claim 1, wherein the RFID tag comprises one of an ink tag and a chip tag.

3. The device of claim 1, wherein the RFID tag comprises an antenna formed from a conductive material substantially impregnated in the component.

4. The device of claim 3, wherein the antenna reflects signals transmitted by the reader for reception thereby, the conductive material forming the antenna being impregnated in the component such that the antenna's ability to reflect the transmitted signals deteriorates as the component wears from prolonged use.

5. The device of claim 4, wherein the conductive material forming the antenna is impregnated in only a portion of the component.

6. The device of claim 5, further comprising a member for receiving or radiating radio waves, the member being coupled to the reader and disposed in proximity with the RFID tag, wherein movement of the component is detected by the reader using the member

7. The device of claim 3, wherein the conductive material forming the antenna is impregnated at a predetermined depth in the component such that the antenna is unable to reflect the signals transmitted by the reader until the component is worn from use.

8. The device of claim 7, wherein the controller determines that the component or a subcomponent thereof needs replacement based upon detection by the reader of a signal reflected by the antenna.

9. The device of claim 3, wherein the controller determines an amount of wear of the component based upon a signal strength of signals reflected by the antenna.

10. The device of claim 9, wherein the controller detects a wear pattern of the component based upon the signal strength of the signals reflected by the antenna.

11. The device of claim 1, wherein the RFID tag comprises a chip tag having stored therein information, a portion of the stored information being updated in real time during system use.

12. The device of claim 1, wherein the component comprises one of a pick member, a wear strip, and a fuser roller of an image forming device.

13. The device of claim 1, wherein the device comprises at least two RFID tags to monitor wearing of at least two components, each of the at least two RFID tag being disposed in or on a respective one of the at least two components.

14. A system component, comprising:
a radio frequency identification (RFID) tag coupled to or disposed on or in the component, wherein signals transmitted by the RFID tag indicate at least one of the component needing to be replaced and the component needing no immediate replacement.

15. The system component of claim 14, wherein the RFID tag comprises an antenna formed from a conductive material impregnated within a portion of the component.

16. The system component of claim 15, wherein the antenna is formed in the component portion such that wear of the component portion deteriorates the antenna.

17. The system component of claim 15, wherein the antenna is formed in the component portion such that the antenna cannot reflect signals until the component portion is sufficiently worn.

18. The system component of claim 15, wherein the conductive material is impregnated in only a portion of the component portion.

19. The system component of claim 14, wherein the RFID tag comprises an RFID chip tag disposed on or in the component.

20. A system, comprising:
one or more components, each component including an RFID tag;
a reader communicatively coupled to the RFID tag of the one or more components; and
a controller communicatively coupled to the reader for determining an amount of wear of each of the one or more components based upon communication between the RFID tag thereof and the reader.

21. The system of claim 20, wherein the controller determines, for each of the one or more components, whether the component has appreciably worn from use and needs replacement based upon the communication between the RFID tag and the reader.

22. The device of claim 21, wherein the controller determines, for each of the one or more components, whether the component has appreciably worn from use and needs replacement based upon at least one of the RFID tag of the component no longer communicating with the reader, the RFID tag of the component beginning to communicate with the reader, and the RFID tag of the component providing information relating to use of the component stored in memory of the RFID tag.
